(19) United States
(12) Patent Application Publication
(10) Pub. No.: US 2025/0303895 A1
(43) Pub. Date: Oct. 2, 2025

(54) ELECTRIC POWER SUPPLYING SYSTEM FOR VEHICLE, POWER SUPPLYING DEVICE FOR VEHICLE, INTERMEDIATE DEVICE, AND POWER SUPPLYING ASSEMBLY FOR VEHICLE

(71) Applicant: Shimano Inc., Osaka (JP)

(72) Inventor: Toshihiko TAKAHASHI, Osaka (JP)

(21) Appl. No.: 19/038,264

(22) Filed: Jan. 27, 2025

(30) Foreign Application Priority Data
Mar. 29, 2024 (JP) 2024-057001

(51) Int. Cl. B60L 53/30; B60L 53/18; B62J 43/13; H02J 7/00

(52) U.S. Cl. CPC B60L 53/30; B60L 53/18; B62J 43/13; H02J 7/0013; H02J 7/0036; B60L 2200/12

(57) ABSTRACT

An electric power supplying system includes a power supplying device and a charging device. The power supplying device is provided outside a vehicle and includes a power supplying unit. The charging device is configured to charge a battery of the vehicle with electric power supplied from the power supplying device and includes a charging unit configured to be connectable to the power supplying unit. The power supplying device includes a connection state determination unit configured to determine a connection state of the power supplying device and the charging device.

### CROSS-REFERENCE TO RELATED APPLICATIONS

This application claims priority to Japanese Patent Application No. 2024-057001, filed on Mar. 29, 2024. The entire disclosure of Japanese Patent Application No. 2024-057001 is hereby incorporated herein by reference.

### BACKGROUND

### Technical Field

The present disclosure generally relates to an electric power supplying system for a vehicle, a power supplying device for a vehicle, an intermediate device, and a power supplying assembly for a vehicle.

### Background Information

Japanese Laid-Open Patent Publication No. 2019-199235 discloses an electric power supplying system that charges a battery of a vehicle with a power supplying device provided outside the vehicle.

### SUMMARY

An objective of the present disclosure is to provide an electric power supplying system for a vehicle, a power supplying device for a vehicle, an intermediate device, and a power supplying assembly for a vehicle that allow a battery of a vehicle to be charged in a preferred manner.

An electric power supplying system in accordance with a first aspect of the present disclosure is for a vehicle. The electric power supplying system comprises a power supplying device provided outside the vehicle and including a power supplying unit, and a charging device configured to charge a battery of the vehicle with electric power supplied from the power supplying device and including a charging unit configured to be connectable to the power supplying unit. The power supplying device includes a connection state determination unit configured to determine a connection state of the power supplying device and the charging device.

With the electric power supplying device in accordance with the first aspect, the connection state determination unit included in the power supplying device is able to determine the connection state of the power supplying device and the charging device. This allows the power supplying device to charge the vehicle battery in a preferred manner.

In accordance with a second aspect of the present disclosure, the electric power supplying system according to the first aspect is configured so that the power supplying unit includes a power supplying unit resistive circuit, the charging unit includes a charging unit resistive circuit, the power supplying unit resistive circuit includes a first power supplying unit line and a second power supplying unit line, and the charging unit resistive circuit includes a first charging unit line and a second charging unit line. A connection of the charging unit to the power supplying unit electrically connects the first charging unit line to the first power supplying unit line between the power supplying unit and the charging unit, and electrically connects the second power supplying unit line to the second charging unit line between the power supplying unit and the charging unit.

With the electric power supplying system in accordance with the second aspect, connection of the charging unit to the power supplying unit electrically connects the first charging unit line to the first power supplying unit line and electrically connects the second power supplying unit line to the second charging unit line. Thus, in the connection state, the charging unit resistive circuit is connected to the power supplying unit resistive circuit in a preferred manner.

In accordance with a third aspect of the present disclosure, the electric power supplying system according to the second aspect is configured so that the charging unit resistive circuit includes a pull-up resistor connected between the first charging unit line and the second charging unit line, and a first pull-down resistor connected between the second charging unit line and ground.

With the electric power supplying system in accordance with the third aspect, the pull-up resistor and the first pull-down resistor change the voltages at the power supplying unit resistive circuit and the charging unit resistive circuit in a preferred manner.

In accordance with a fourth aspect of the present disclosure, the electric power supplying system according to the second or third aspect is configured so that the power supplying unit resistive circuit includes a second pull-down resistor connected between the second power supplying unit line and ground.

With the electric power supplying system in accordance with the fourth aspect, the second pull-down resistor changes the voltages at the power supplying unit resistive circuit and the charging unit resistive circuit in a preferred manner.

In accordance with a fifth aspect of the present disclosure, the electric power supplying system according to the fourth aspect is configured so that the battery includes a first battery and a second battery that differs from the first battery. The charging device includes a first charging device configured to charge the first battery, and a second charging device configured to charge the second battery. The power supplying device is configured to be connected to one of the first charging device and the second charging device. The connection state includes a first connection state in which the first charging device is connected to the power supplying device, and a second connection state in which the second charging device is connected to the power supplying device. The connection state determination unit is configured to determine whether the connection state is the first connection state or the second connection state.

The electric power supplying system in accordance with the fifth aspect allows for determination of whether the power supplying device is connected to the first charging device in the first connection state or whether the power supplying device is connected to the second charging device in the second connection state.

In accordance with a sixth aspect of the present disclosure, the electric power supplying system according to any one of the second to fifth aspects further comprises an intermediate device connected between the power supplying device and the charging device. The connection state determination unit is configured to determine whether the intermediate device is connected between the power supplying device and the charging device upon connection of the charging unit to the power supplying unit via the intermediate device.

With the electric power supplying system in accordance with the sixth aspect, the power supplying device can determine whether the intermediate device is connected.

In accordance with a seventh aspect of the present disclosure, in the electric power supplying system according to the sixth aspect, the connection state determination unit is configured to determine a type of the intermediate device connected between the power supplying device and the charging device.

With the electric power supplying system in accordance with the seventh aspect, the power supplying device can determine the type of the intermediate device.

In accordance with an eighth aspect of the present disclosure, in the electric power supplying system according to the sixth or seventh aspect, the intermediate device includes a first intermediate unit configured to be connectable to the power supplying unit, a second intermediate unit configured to be connectable to the charging unit, and an intermediate unit resistive circuit provided between the first intermediate unit and the second intermediate unit. The intermediate unit resistive circuit includes a first intermediate unit line electrically connected to the first power supplying unit line and the first charging unit line, a second intermediate unit line electrically connected to the second power supplying unit line and the second charging unit line, and a third pull-down resistor connected between the second charging unit line and ground.

With the electric power supplying system in accordance with the eighth aspect, the third pull-down resistor allows the voltages at the power supplying unit resistive circuit, the charging unit resistive circuit, and the intermediate unit resistive circuit to be changed.

In accordance with a ninth aspect of the present disclosure, in the electric power supplying system according to any one of the second to eighth aspects, the connection state determination unit is configured to determine whether the connection state is anomalous.

With the electric power supplying device in accordance with the ninth aspect, the connection state determination unit included in the power supplying device is able to determine whether the connection state is anomalous.

In accordance with a tenth aspect of the present disclosure, in the electric power supplying system according to the ninth aspect, the connection state determination unit is configured to determine that the connection state is anomalous in a case where a state determination voltage between the second charging unit line and ground is outside a predetermined range.

With the electric power supplying system according to the tenth aspect, the connection state determination unit determines that the connection state is anomalous in a case where the state determination voltage is outside the predetermined range.

In accordance with an eleventh aspect of the present disclosure, in the electric power supplying system according to the tenth aspect, the power supplying device further includes power supplying storage that stores association information associating the state determination voltage with the connection state, and the connection state determination unit is configured to determine the connection state based on the state determination voltage and the association information.

With the electric power supplying system according to the eleventh aspect, the connection state is determined based on the state determination voltage and the association information.

In accordance with a twelfth aspect of the present disclosure, in the electric power supplying system according to any one of the first to eleventh aspects, the power supplying device includes a supplying state switching unit configured to switch a supplying state of electric power to the charging device, and a power supplying controller configured to control the supplying state switching unit so that electric power is supplied to the charging device based on a determination result of the connection state obtained by the connection state determination unit.

With the electric power supplying device in accordance with the twelfth aspect, the power supplying device switches the supplying state of electric power to the charging device based on the determination result of the connection state.

In accordance with a thirteenth aspect of the present disclosure, in the electric power supplying system according to any one of the first to twelfth aspects, the charging device includes an electric wire provided with the charging unit, and a connection notification unit configured to transmit a connection signal to the connection state determination unit upon connection of the charging unit to the power supplying unit. The connection notification unit is provided on the electric wire.

With the electric power supplying device in accordance with the thirteenth aspect, the connection signal transmitted from the connection notification unit, which is provided on the electric wire, allows for determination of the connection state.

In accordance with a fourteenth aspect of the present disclosure, in the electric power supplying system according to any one of the first to thirteenth aspects, at least part of the charging device is provided on the vehicle.

With the electric power supplying device in accordance with the fourteenth aspect, the power supplying device is able to determine the connection state of the charging device, which is at least partially provided on the vehicle.

In accordance with a fifteenth aspect of the present disclosure, in the electric power supplying system according to any one of the first to fourteenth aspects, the power supplying device further includes a notification unit configured to notify a user of the connection state determined by the connection state determination unit.

With the electric power supplying device in accordance with the fifteenth aspect, the power supplying device includes the notification unit. This allows the user to recognize the connection state in a case where the charging device is connected to the power supplying device.

In accordance with a sixteenth aspect of the present disclosure, in the electric power supplying system according to any one of the first to fifteenth aspects, the vehicle includes a human-powered vehicle.

With the electric power supplying system according to the sixteenth aspect, a battery of the human-powered vehicle can be charged in a preferred manner.

A power supplying device in accordance with a seventeenth aspect of the present disclosure is for a vehicle. The power supplying device is configured to be connected to a charging device configured to charge a battery of the vehicle. The power supplying device comprises a power supplying unit provided outside the vehicle and configured to be connectable to a charging unit of the charging device, and a connection state determination unit configured to determine a connection state of the power supplying device and the charging device.

With the electric power supplying device in accordance with the seventeenth aspect, the power supplying device is able to determine the connection state of the power supplying device and the charging device. This allows the power supplying device to charge the vehicle battery in a preferred manner.

In accordance with an eighteenth aspect of the present disclosure, the power supplying device according to the seventeenth aspect is configured so that the power supplying unit includes a power supplying unit resistive circuit, and the power supplying unit resistive circuit includes a power supplying unit line electrically connected to a charging unit line of the charging unit, and a pull-down resistor connected between the power supplying unit line and ground.

With the electric power supplying system in accordance with the eighteenth aspect, the pull-down resistor changes the voltage at the power supplying unit resistive circuit in a preferred manner.

An intermediate device in accordance with a nineteenth aspect of the present disclosure is connected between the power supplying device according to the eighteenth aspect and the charging device. The intermediate device comprises an intermediate unit resistive circuit. The intermediate unit resistive circuit includes an intermediate unit line configured to be electrically connected to the power supplying unit line, and a pull-down resistor connected between the intermediate unit line and ground.

With the intermediate device in accordance with the nineteenth aspect, the third pull-down resistor, which is included in the intermediate unit resistive circuit, allows the voltages at the power supplying unit resistive circuit and the intermediate unit resistive circuit to be changed.

A power supplying assembly in accordance with a twentieth aspect is for a vehicle. The power supplying assembly comprises an intermediate device connected between the power supplying device and the charging device. The intermediate device includes an intermediate unit resistive circuit. The intermediate unit resistive circuit includes an intermediate unit line electrically connecting the charging unit and the power supplying unit, and a pull-down resistor connected between the intermediate unit line and ground.

With the power supplying assembly in accordance with the twentieth aspect, the pull-down resistor changes the voltage at the power supplying unit resistive circuit and the intermediate unit resistive circuit in a preferred manner.

The electric power supplying system for a vehicle, the power supplying device for a vehicle, the intermediate device, and the power supplying assembly for a vehicle allow a battery of a vehicle to be charged in a preferred manner.

### BRIEF DESCRIPTION OF THE DRAWINGS

Referring now to the attached drawings which form a part of this original disclosure, an illustrative embodiment is shown.

FIG. 1 is a schematic diagram illustrating a power supplying system for a vehicle in accordance with one embodiment and a human-powered vehicle (e.g., a bicycle).

FIG. 2 is a block diagram showing the electrical configuration of the power supplying system illustrated in FIG. 1.

FIG. 3 is a circuit diagram of a charging unit resistive circuit and a power supplying unit resistive circuit illustrated in FIG. 2.

FIG. 4 is a schematic diagram illustrating the power supplying system, which includes an intermediate device, and the human-powered vehicle.

FIG. 5 is a block diagram showing the electrical configuration of the power supplying system illustrated in FIG. 4.

FIG. 6 is a circuit diagram of a charging unit resistive circuit and a power supplying unit resistive circuit illustrated in FIG. 5.

FIG. 7 is a flowchart of a process for determining a connection state with a power supplying unit illustrated in FIG. 1.

FIG. 8 is a schematic diagram illustrating a power supplying system for a vehicle in accordance with a modification and a human-powered vehicle.

FIG. 9 is a block diagram showing the electrical configuration of the power supplying system illustrated in FIG. 8.

### DETAILED DESCRIPTION

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

### Embodiment

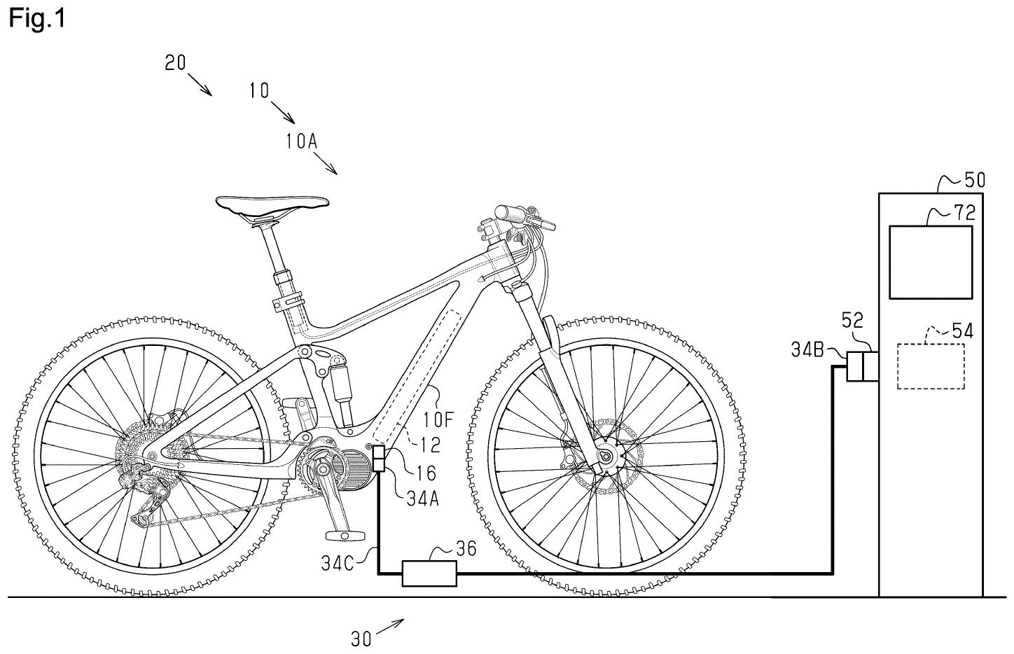

As seen in FIG. 1, a vehicle 10 is illustrated that is electrically connected to an electric power supplying system 20 for receiving electric power from the electric power supplying system 20. The electric power supplying system 20 includes a power supplying assembly 20A and a power supplying device 50. With reference to FIGS. 1 to 7, the electric power supplying system 20, the power supplying assembly 20A, and the power supplying device 50 will now be described.

The electric power supplying system 20 illustrated in FIG. 1 is a system for supplying a battery 12 provided in the vehicle 10 with electric power from an external device. The vehicle 10 includes, for example, at least one of a human-powered vehicle 10A, an electric vehicle, a plug-in hybrid electric vehicle, a hybrid electric vehicle, and an electric bicycle. The vehicle 10 does not have to be driven by electric power and can include electric components actuated by electric power. The vehicle 10 of the present embodiment includes, for example, the human-powered vehicle 10A. The vehicle 10 will refer to the human-powered vehicle 10A in the description of the embodiment hereafter.

The human-powered vehicle 10A is a vehicle that includes at least one wheel and is driven by at least a human driving force. The human-powered vehicle 10A includes, for example, various types of bicycles such as a mountain bike, a road bike, a city bike, a cargo bike, a handcycle, and a recumbent bike. The number of wheels of the human-powered vehicle 10A is not limited. The human-powered vehicle 10A includes, for example, a monocycle and vehicles having two or more wheels. The human-powered vehicle 10A is not limited to a vehicle driven by only a human driving force. The human-powered vehicle 10A includes an e-bike that uses not only a human driving force but also a drive force of an electric motor for propulsion. An e-bike includes an electric assist bicycle that uses an electric motor to assist in propulsion. The human-powered vehicle 10A will refer to an electric assist bicycle in the embodiment described hereafter.

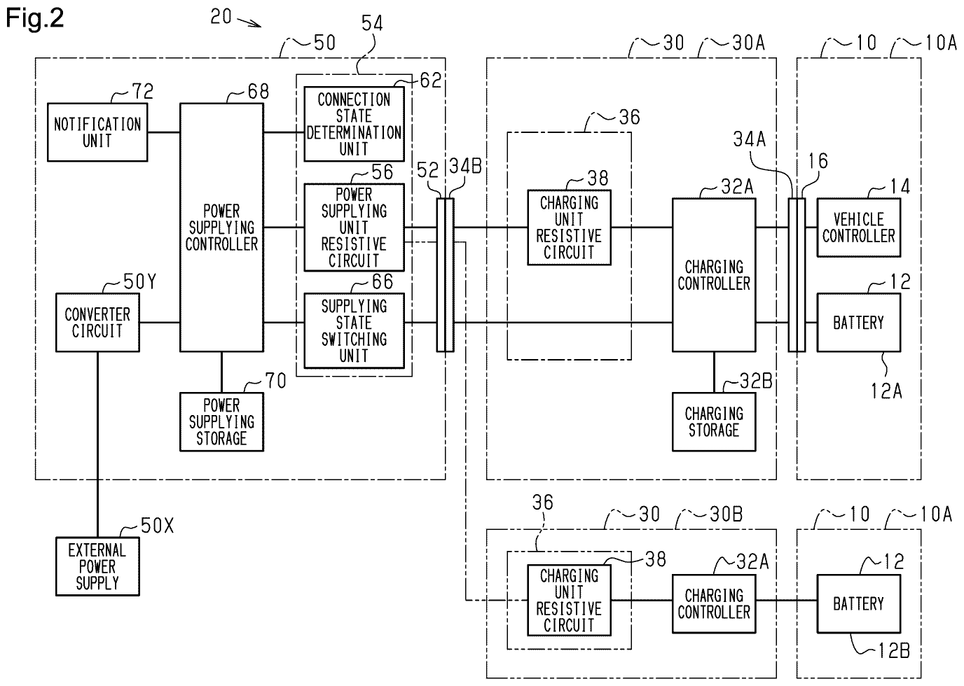

As seen in FIGS. 1 and 2, the vehicle 10 includes the battery 12, which is for a vehicle. The battery 12 supplies electric power to one or more electric components of the human-powered vehicle 10A. The electric component includes, for example, at least one of a drive unit for assisting in propulsion of the human-powered vehicle 10A, an electric brake device, an electric transmission device, an electric seatpost, an electric suspension, and a cycle computer.

The battery 12 includes, for example, a rechargeable battery. The rechargeable battery includes, for example, a nickel metal hydride battery, a lithium-ion battery, or the like. The rechargeable battery can be, for example, a lead-acid battery, a solid-state battery, or the like as long as discharging and charging can be repeated. The battery 12 is provided on the vehicle 10. The battery 12 is provided on, for example, a frame 10F of the human-powered vehicle 10A. The battery 12 is, for example, accommodated inside the frame 10F. The battery 12 can be attached to the outer surface of the frame 10F. The battery 12 is, for example, attachable to and detachable from the frame 10F. As long as the battery 12 can be mounted on the human-powered vehicle 10A, the battery 12 can be mounted at any part of the human-powered vehicle 10A. The battery 12 is, for example, provided on a downtube of the frame 10F. The battery 12 is provided on, for example, an upper surface of the downtube. The battery 12 can be mounted on a rear carrier of the human-powered vehicle 10A. The rear carrier is attached to, for example, the rear part of the frame 10F. The frame 10F includes, for example, a battery holder that holds the battery 12. The battery 12 can be provided on an electric component. In a case where the battery 12 is provided on an electric component, the electric component includes a battery holder. The battery 12 is configured to be chargeable in a state held in the battery holder. In a case where the battery 12 is configured to be chargeable in a state held in the battery holder, at least one of the battery 12 and the battery holder includes a structure for supplying electric power from the electric power supplying system 20 to the battery 12. For example, the battery holder includes an opening exposing a charging terminal of the battery 12 or an electric connector for connecting a charging terminal of the battery 12 to a charging device 30 of the electric power supplying system 20.

As shown in FIG. 2, the vehicle 10 includes, for example, a vehicle controller 14. The vehicle controller 14 includes, for example, at least one processor configured to run programs and execute various types of control. The processor includes, for example, a central processing unit (CPU) or a micro-processing unit (MPU). The vehicle controller 14 can include one or more microcomputers. The vehicle controller 14 can include a plurality of processors located at separate positions. The vehicle controller 14 can be formed of one or more semiconductor chips that are mounted on a printed circuit board. The vehicle controller 14 can also be referred to as an electronic controller. The terms “controller” and “electronic controller” as used herein refer to hardware that executes a software program, and does not include a human being.

The vehicle 10 can include vehicle storage. The vehicle storage stores, for example, programs for executing various types of control and information used in control processes. The vehicle storage includes, for example, at least one of a nonvolatile memory and a volatile memory. The nonvolatile memory includes, for example, at least one of a read-only memory (ROM), an erasable programmable read-only memory (EPROM), an electrically erasable programmable read-only memory (EEPROM), and a flash memory. The volatile memory includes, for example, a random-access memory (RAM).

The vehicle controller 14, for example, executes electrical control on the vehicle 10. The vehicle controller 14 controls, for example, an electric component of the human-powered vehicle 10A. The vehicle controller 14 executes control related to, for example, charging of the battery 12.

The vehicle 10 includes, for example, a vehicle connector 16. The vehicle connector 16 is, for example, electrically connected to a charging unit 36. The vehicle 10 is configured to be connected by the vehicle connector 16 to the charging device 30. The vehicle connector 16 can also be referred to as a vehicle electrical connector 16.

As shown in FIG. 1, the electric power supplying system 20 is a system for supplying electric power to the battery 12. The electric power supplying system 20 includes the charging device 30 and the power supplying device 50.

The charging device 30 is, for example, configured to charge the battery 12. The charging device 30 is configured to charge the battery 12 with the electric power supplied from the power supplying device 50. The charging device 30 is provided, for example, outside the vehicle 10. The charging device 30 can also be referred to as a battery charger 30.

The power supplying device 50 is connected to the charging device 30. The power supplying device 50 is configured to supply electric power to the charging device 30. The power supplying device 50 supplies the battery 12 with electric power through an electric wire 34C of the charging device 30. The power supplying device 50 is provided outside the vehicle 10. The power supplying device 50 is, for example, a vehicle charging station. The power supplying device 50 is provided, for example, on a street. The power supplying device 50 can be provided in a driveway of a house. The power supplying device 50 includes a power supplying unit 54. The power supplying unit 54 is configured to be connectable to the charging unit 36 of the charging device 30. The power supplying unit 54 is provided outside the vehicle 10.

As shown in FIG. 2, the charging device 30 includes a charging controller 32A and a charging storage 32B. The charging controller 32A includes, for example, at least one processor configured to run programs and execute various types of control. The charging controller 32A can include one or more microcomputers. The charging controller 32A can include a plurality of processors located at separate positions.

The charging storage 32B stores, for example, programs for executing various types of control and information used in control processes. The charging storage 32B includes, for example, at least one of a nonvolatile memory and a volatile memory. The nonvolatile memory includes, for example, at least one of a ROM, an EPROM, an EEPROM, and a flash memory. The volatile memory includes, for example, a RAM.

As shown in FIGS. 1 and 2, the charging device 30 includes, for example, a vehicle-side wire connector 34A. For example, a connection of the vehicle-side wire connector 34A to the vehicle connector 16 electrically connects the charging device 30 to the vehicle 10. The vehicle-side wire connector 34A can also be referred to as a vehicle-side electrical connector 34A. The charging controller 32A is, for example, configured to perform controller area network (CAN) communication with the vehicle controller 14 via the vehicle-side wire connector 34A. The charging controller 32A can perform power line communication (PLC) or universal asynchronous receiver transmitter (UART) communication with the vehicle controller 14.

The charging device 30 includes, for example, a power supplying device-side wire connector 34B and the electric wire 34C. For example, a connection of the power supplying device-side wire connector 34B to the power supplying device 50 electrically connects the charging device 30 to the power supplying device 50. The electric wire 34C is, for example, an electric cable. One end of the electric wire 34C includes the vehicle-side wire connector 34A, and the other end of the electric wire 34C includes the power supplying device-side wire connector 34B. The power supplying device-side wire connector 34B can also be referred to as a power-side electrical connector 34B.

The charging device 30 includes the charging unit 36. The charging unit 36 is configured to be connectable to the power supplying unit 54. For example, the charging unit 36 is provided on the electric wire 34C. For example, electric power is supplied via the charging unit 36 to the battery 12. The charging unit 36 includes, for example, a charging unit resistive circuit 38. The charging controller 32A and the charging storage 32B can be provided in the charging unit 36.

The electric wire 34C is connected to a charging terminal of the battery 12, for example, in a case where the electric power supplying system 20 charges the battery 12. The electric wire 34C is disconnected from the battery 12, for example, in a case where the vehicle 10 is traveling. The electric wire 34C is, for example, an external device of the vehicle 10. In an arrangement in which the charging unit 36 is provided on the electric wire 34C, the charging unit 36 is provided outside the vehicle 10.

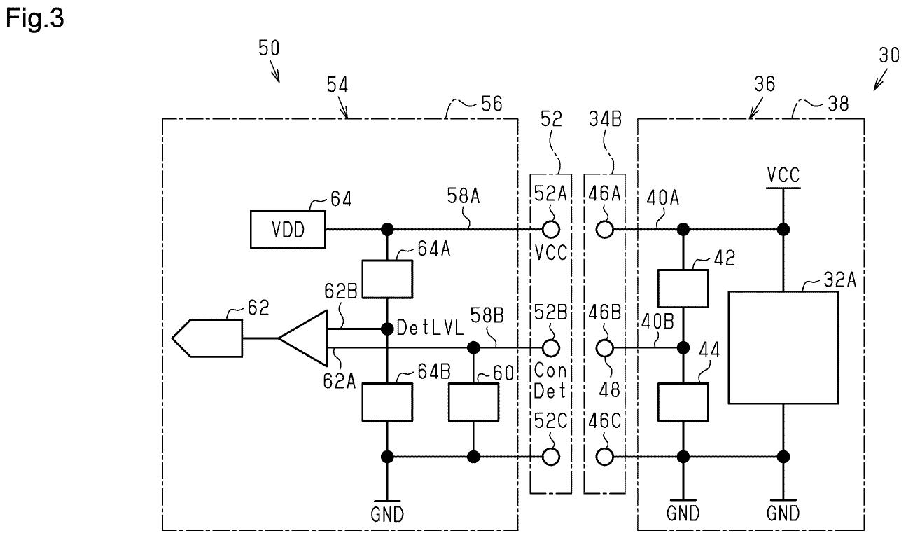

As shown in FIG. 3, the charging unit resistive circuit 38 includes, for example, a first charging unit line 40A and a second charging unit line 40B. The charging unit resistive circuit 38 includes, for example, a pull-up resistor 42 and a first pull-down resistor 44. The pull-up resistor 42 is connected, for example, between the first charging unit line 40A and the second charging unit line 40B. The first pull-down resistor 44 is connected, for example, between the second charging unit line 40B and ground.

The power supplying device-side wire connector 34B includes a first charging terminal 46A, a second charging terminal 46B, and a third charging terminal 46C. The first charging terminal 46A is connected to the first charging unit line 40A. The second charging terminal 46B is connected to the second charging unit line 40B. The third charging terminal 46C is connected to ground.

The charging unit resistive circuit 38 includes, for example, a connection notification unit 48. The connection notification unit 48 is configured to transmit a connection signal to a connection state determination unit 62 upon connection of the charging unit 36 to the power supplying unit 54. The connection notification unit 48 includes, for example, the second charging terminal 46B.

As shown in FIGS. 2 and 3, the charging device 30 includes, for example, the electric wire 34C and the connection notification unit 48. The connection notification unit 48 is provided on, for example, the electric wire 34C.

As shown in FIG. 2, the power supplying device 50 is connected to, for example, an external power supply 50X provided outside the power supplying device 50. The external power supply 50X includes, for example, a commercial power supply. The power supplying device 50 supplies electric power from the external power supply 50X to the charging device 30. The power supplying device 50 includes, for example, a converter circuit 50Y. The converter circuit 50Y converts the electric power from the external power supply 50X to electric power that is suitable for charging the battery 12 of the vehicle 10. The converter circuit 50Y includes, for example, an AC/DC converter that converts the alternating current input from the external power supply 50X to direct current, and a CC/CV converter that converts the voltage of the current input from the AC/DC converter to a predetermined voltage.

The power supplying device 50 includes, for example, a power supplying connector 52. The power supplying connector 52 can also be referred to as a power supplying electrical connector 52. A connection of the power supplying device-side wire connector 34B of the charging device 30 to the power supplying connector 52 electrically connects the power supplying device 50 to the charging device 30. A power supplying controller 68 is configured to, for example, perform CAN communication with the charging controller 32A via the power supplying connector 52. The power supplying controller 68 can perform PLC or UART communication with the charging controller 32A.

The power supplying unit 54 is configured to be connectable to the charging unit 36 of the charging device 30. The power supplying unit 54 includes, for example, a power supplying unit resistive circuit 56.

As shown in FIG. 3, the power supplying unit resistive circuit 56 includes, for example, a first power supplying unit line 58A and a second power supplying unit line 58B. The power supplying unit resistive circuit 56 includes, for example, a second pull-down resistor 60. The second pull-down resistor 60 is connected, for example, between the second power supplying unit line 58B and ground.

Connection of the charging unit 36 to the power supplying unit 54 electrically connects the first charging unit line 40A and the first power supplying unit line 58A between the power supplying unit 54 and the charging unit 36. Further, connection of the charging unit 36 to the power supplying unit 54 electrically connects the second power supplying unit line 58B and the second charging unit line 40B between the power supplying unit 54 and the charging unit 36.

The power supplying connector 52 includes a first power supplying terminal 52A, a second power supplying terminal 52B, and a third power supplying terminal 52C. The first power supplying terminal 52A is connected to the first power supplying unit line 58A. The second power supplying terminal 52B is connected to the second power supplying unit line 58B. The third power supplying terminal 52C is connected to ground. Connection of the charging unit 36 to the power supplying unit 54 connects the first charging terminal 46A to the first power supplying terminal 52A, the second charging terminal 46B to the second power supplying terminal 52B, and the third charging terminal 46C to the third power supplying terminal 52C.

The power supplying device 50 includes the connection state determination unit 62. The power supplying device 50 includes the power supplying unit 54 and the connection state determination unit 62. The connection state determination unit 62 is configured to determine the connection state of the power supplying device 50 and the charging device 30. The connection state determination unit 62 is, for example, included in the power supplying unit resistive circuit 56. The connection state determination unit 62 can be included in, for example, the power supplying controller 68.

The power supplying unit resistive circuit 56 includes a voltage application unit 64. The voltage application unit 64 is connected to the first power supplying unit line 58A. The voltage application unit 64 applies voltage VDD to the first power supplying unit line 58A. The voltage application unit 64 is supplied with electric power from, for example, the external power supply 50X. The voltage VDD of the voltage application unit 64 is, for example, 5 V. The voltage VDD of the voltage application unit 64 is not limited to 5 V and can be any predetermined voltage such as 2.5 V, 3.3 V, or 12 V.

The power supplying unit resistive circuit 56 includes a first resistor 64A, which is connected to the first power supplying unit line 58A, and a second resistor 64B, which is connected between the first resistor 64A and ground. The connection state determination unit 62 is connected between the first resistor 64A and the second resistor 64B.

The connection state determination unit 62 includes a first input 62A and a second input 62B. The first input 62A and the second input 62B are provided in an operational amplifier of the connection state determination unit 62. The first input 62A receives voltage ConDet from the second power supplying terminal 52B. Voltage ConDet is decreased by the pull-up resistor 42, the first pull-down resistor 44, and the second pull-down resistor 60. The second input 62B receives voltage DetLVL, which is decreased by the resistance ratio of the first resistor 64A and the second resistor 64B.

The connection state determination unit 62 is configured to determine a connection state based on a state determination voltage VX. The state determination voltage VX includes, for example, the voltage between the second power supplying unit line 58B and ground. The state determination voltage VX includes, for example, the voltage ConDet. The connection state determination unit 62 determines the connection state by comparing, for example, the voltage ConDet and the voltage DetLVL. The connection state determination unit 62, for example, determines that the power supplying unit 54 is connected to the charging unit 36 when the voltage ConDet is greater than the voltage DetLVL.

As shown in FIG. 2, the power supplying device 50 includes, for example, a supplying state switching unit 66 and the power supplying controller 68. The supplying state switching unit 66 is configured to switch the supplying state of electric power to, for example, the charging device 30. The supplying state includes, for example, a non-supplying state in which electric power is not supplied to the charging device 30. The supplying state includes, for example, a first supplying state, a second supplying state in which the supplied electric power is greater than that in the first supplying state, and a third supplying state in which the supplied electric power is greater than that in the second supplying state. The supplied electric power in each supplying state is set, for example, in accordance with the electric power conditions of the battery 12. The supplied electric power in the first supplying state is, for example, electric power of 400 W or less. The supplied electric power in the second supplying state is, for example, electric power that is greater than 400 W and less than 1 kW. The supplied electric power in the third supplying state is, for example, electric power that is greater than or equal to 1 kW. The supplying state can include, for example, only one of the first supplying state, the second supplying state, and the third supplying state. The supplying state switching unit 66 switches the supplying state from the non-supplying state to one of the first supplying state, the second supplying state, and the third supplying state to start supplying power from the power supplying device 50 to the charging device 30.

The power supplying controller 68 includes, for example, a processor configured to run programs and execute various types of control. The power supplying controller 68 can include one or more microcomputers. The power supplying controller 68 can include a plurality of processors located at separate positions.

The power supplying controller 68 is configured to control the supplying state switching unit 66 so that electric power is supplied to the charging device 30 based on, for example, the determination result of the connection state of the connection state determination unit 62. The power supplying controller 68, for example, controls the supplying state switching unit 66 to control the supplying state of electric power to the charging device 30. For example, upon determination that the power supplying unit 54 is connected to the charging unit 36, the power supplying controller 68 has the supplying state switching unit 66 switch the supplying state from the non-supplying state to one of the first supplying state, the second supplying state, and the third supplying state.

The power supplying device 50 further includes, for example, power supplying storage 70. The power supplying storage 70 stores, for example, programs for executing various types of control and information used in control processes. The power supplying storage 70 includes, for example, at least one of a nonvolatile memory and a volatile memory. The nonvolatile memory includes, for example, at least one of a ROM, an EPROM, an EEPROM, and a flash memory. The volatile memory includes, for example, a RAM. The power supplying storage 70 stores, for example, association information associating the state determination voltage VX with the connection state.

The power supplying device 50 further includes, for example, a notification unit 72. The notification unit 72 is configured to notify a user of the connection state determined by the connection state determination unit 62. The notification unit 72 is, for example, an indicator such as a display or an indication lamp. The notification unit 72 can be a speaker that generates voice, sound, or the like. The user is, for example, the person using the electric power supplying system 20. The user can be the person using the vehicle 10.

The power supplying device 50 can be configured to supply power to, for example, multiple types of batteries 12. The batteries 12 include, for example, a first battery 12A and a second battery 12B, which differs from the first battery 12A. The second battery 12B differs from the first battery 12A, for example, in the electric power conditions. The electric power conditions include, for example, at least one of the voltage at an electric power supplying circuit, the current at an electric power supplying circuit, and the supplied electric power. The supplied electric power is, for example, equal to the product of the voltage of the supplied electric power and the current of the supplied electric power. The second battery 12B can be a battery 12 that is provided on the same vehicle 10 as the first battery 12A or a battery 12 provided on a vehicle 10 that differs from the vehicle 10 on which the first battery 12A is provided. During the charging of the battery 12, the power supplying device 50 is configured to be connected to, for example, a single battery 12. For example, if connected to the first battery 12A, the power supplying device 50 is not connected to the second battery 12B. For example, if connected to the second battery 12B, the power supplying device 50 is not connected to the first battery 12A.

Referring to FIGS. 2 and 3, for example, from multiple types of charging devices 30, the electric power supplying system 20 selects a charging device 30 that corresponds to the type of the battery 12. The multiple types of charging devices 30 differ from one another, for example, in the electric power conditions. From the multiple types of charging devices 30, the electric power supplying system 20 uses, for example, the charging device 30 that corresponds to the electric power conditions of the battery 12. The charging device 30 includes, for example, a first charging device 30A and a second charging device 30B. The first charging device 30A is configured to, for example, charge the first battery 12A. The second charging device 30B is configured to, for example, charge the second battery 12B. The first charging device 30A and the second charging device 30B differ in at least one of the pull-up resistance RU of the pull-up resistor 42 and the first pull-down resistance RD10 of the first pull-down resistor 44. In one example, in a case where the electric power conditions of the second charging device 30B are greater than the electric power condition of the first charging device 30A, the pull-up resistance RU of the second charging device 30B is less than the pull-up resistance RU of the first charging device 30A. Further, in a case where the supplied electric power of the second charging device 30B is greater than the electric power conditions of the first charging device 30A, the first pull-down resistance RD10 of the second charging device 30B is greater than the first pull-down resistance RD10 of the first charging device 30A.

In each of the charging devices 30 and the batteries 12, the pull-up resistance RU and the first pull-down resistance RD10 are set in accordance with the voltage, the current, and the supplied electric power. The electric power supplying system 20, for example, allows for the usage of the multiple types of charging devices 30. The pull-up resistance RU and the first pull-down resistance RD10 of each charging device 30 are set in accordance with, for example, the type of the charging device 30. The pull-up resistance RU and the first pull-down resistance RD10 of each battery 12 are set in accordance with, for example, the type of the battery 12.

Table 1 illustrates examples of the pull-up resistance RU and the first pull-down resistance RD10 set in association with the electric power conditions of the charging devices 30 and the batteries 12. The pull-up resistance RU and the first pull-down resistance RD10 can each be set to be of the same value even when the electric power conditions differ partially. In the present embodiment, the combination of the pull-up resistance RU and the first pull-down resistance RD10 can be referred to as the first category. The first category is set in accordance with, for example, the range of the supplied electric power. The first category in Table 1 includes, for example, CAT11, CAT12, and CAT13. The supplied electric power from the power supplying device 50 to the charging device 30 in CAT12 is greater than the supplied electric power from the power supplying device 50 to the charging device 30 in CAT11. The supplied electric power from the power supplying device 50 to the charging device 30 in CAT13 is greater than the supplied electric power from the power supplying device 50 to the charging device 30 in CAT12. The voltage relationship in Table 1 is V1<V2. The current relationship in Table 1 is A1<A2<A3<A4. The supplied electric power relationship in Table 1 is W1<W2<W3<W4<W5. The pull-up resistance RU relationship in Table 1 is RU1>RU2>RU3. The first pull-down resistance RD10 relationship in Table 1 is RD11<RD12<RD13.

TABLE 1

| | Electric Power Condition | | | | |
|---|---|---|---|---|---|
| | | | Supplied | Pull-Up | 1st Pull-Down |
| 1st | | | Electric | Resistance | Resistance |
| Category | Voltage | Current | Power | RU | RD10 |
| CAT11 | V1 | A1 | W1 | RU1 | RD11 |
| | V1 | A2 | W2 | | |
| CAT12 | V1 | A3 | W3 | RU2 | RD12 |
| CAT13 | V2 | A3 | W4 | RU3 | RD13 |
| | V2 | A4 | W5 | | |

V1 is, for example, 48 V. V2 is, for example, 60 V. A1 is, for example, 5 A. A2 is, for example, 10 A. A3 is, for example, 20 A. A4 is, for example, 40 A. W1 is, for example, 240 W. W2 is, for example, 480 W. W3 is, for example, 960 W. W4 is, for example, 1.2 kW. W5 is, for example, 2.4 kW. RU1 is, for example, 5.1Ω. RU2 is, for example, 3.3Ω. RU3 is, for example, 2.2Ω. RD11 is, for example, 1.8Ω. RD12 is, for example, 5.1Ω. RD13 is, for example, 8.1Ω.

Table 2 illustrates the relationship of the first category, the pull-up resistance RU, and the first pull-down resistance RD10, the second pull-down resistance RD20 of the second pull-down resistor 60 set for the power supplying device 50, and the state determination voltage VX. In table 2, the second pull-down resistance RD20 is a second pull-down resistance RD21 in each first category. In Table 2, the state determination voltage VX has the relationship of VX1<VX2<VX3. The second pull-down resistance RD21 is, for example, equal to RU2.

TABLE 2

| | | 1st Pull- | 2nd Pull- | 1st Combined | |
|---|---|---|---|---|---|
| | Pull-Up | Down | Down | Pull-Down | State |
| 1st | Resistance | Resistance | Resistance | Resistance | Determination |
| Category | RU | RD10 | RD20 | RDA | Voltage |
| CAT11 | RU1 | RD11 | RD21 | RDA1 | VX1 |
| CAT12 | RU2 | RD12 | RD21 | RDA2 | VX2 |
| CAT13 | RU3 | RD13 | RD21 | RDA3 | VX3 |

In Table 2, the first combined pull-down resistance RDA indicates the combined resistance of the first pull-down resistor 44 and the second pull-down resistor 60. The first combined pull-down resistance RDA is acquired through, for example, Equation 1, which is shown below. The state determination voltage VX is a voltage decreased from voltage VDD by the resistance ratio of the pull-up resistance RU and the first combined pull-down resistance RDA.

RDA=RD10×RD20/(RD10+RD20) Equation 1

The state determination voltage VX is, for example, set to be greater as the supplied electric power to the charging device 30 of the electric power supplying system 20 increases. The pull-up resistance RU and the first pull-down resistance RD10 are set so that the state determination voltage VX increases as the supplied electric power to the charging device 30 increases. The state determination voltage VX can be set to decrease as the supplied electric power to the charging device 30 of the electric power supplying system 20 increases.

In Table 2, which shows examples of resistances, if the voltage VDD of the voltage application unit 64 is 5 V, the state determination voltage VX1 is, for example, 0.93 V. In Table 2, which shows examples of resistances, if the voltage VDD of the voltage application unit 64 is 5 V, the state determination voltage VX2 is, for example, 1.89 V. In Table 2, which shows examples of resistances, if the voltage VDD of the voltage application unit 64 is 5 V, the state determination voltage VX3 is, for example, 2.58 V.

Referring to FIG. 2, the connection state includes, for example, a first connection state and a second connection state. In the first connection state, the first charging device 30A is connected to the power supplying device 50. In the second connection state, the second charging device 30B is connected to the power supplying device 50. The power supplying device 50 is, for example, configured to be connected to one of the first charging device 30A and the second charging device 30B. The connection state determination unit 62 is, for example, configured to determine whether the connection state is the first connection state or the second connection state. The second charging device 30B differs from the first charging device 30A in, for example, the first category. The connection state determination unit 62, for example, determines from the state determination voltage VX whether the connection state is the first connection state or the second connection state.

The connection state further includes, for example, a third connection state. In the third connection state, a third charging device is connected to the power supplying device 50. The third charging device is, for example, configured to charge a third battery under electric power conditions differing from those of the first battery 12A and the second battery 12B. The third charging device differs from both the first charging device 30A and the second charging device 30B in, for example, the first category. The connection state determination unit 62 is, for example, configured to determine whether the connection state is the first connection state, the second connection state, or the third connection state.

The connection state corresponds to, for example, the first category. The connection state determination unit 62, for example, determines the first category based on the state determination voltage VX. For example, CAT11 corresponds to the first connection state, CAT12 corresponds to the second connection state, and CAT13 corresponds to the third connection state. The connection state determination unit 62, for example, determines from the state determination voltage VX whether the first category of the charging device 30 is CAT11, CAT12, or CAT13. The connection state determination unit 62, for example, can be configured to determine at least one of the type of the charging device 30 and the type of the battery 12 by determining whether the first category is CAT11, CAT12, or CAT13.

The connection state determination unit 62, for example, determines the connection state based on the state determination voltage VX and the association information. The association information, for example, allows for determination of the first category. The association information includes, for example, threshold values. The association information includes, for example, a table specified by threshold values. The threshold values, for example, are set for each category type included in the first category. For example, in a case where the state determination voltage VX is within a range of the threshold values set for the first connection state, the connection state determination unit 62 determines that the connection state is the first connection state. For example, in a case where the state determination voltage VX is within a range of the threshold values set for the second connection state, the connection state determination unit 62 determines that the connection state is the second connection state. The threshold values include, for example, an upper limit threshold value and a lower limit threshold value for each category type. For example, if the state determination voltage VX is within a range that is greater than a first lower limit threshold value for determining CAT11 and less than or equal to a first upper limit threshold value for determining CAT11, the connection state determination unit 62 determines that the first category is CAT11. For example, if the state determination voltage VX is within a range that is greater than a second lower limit threshold value for determining CAT12 and less than or equal to a second upper limit threshold value for determining CAT12, the connection state determination unit 62 determines that the first category is CAT12. For example, if the state determination voltage VX is within a range that is greater than a third lower limit threshold value for determining CAT13 and less than or equal to a third upper limit threshold value for determining CAT13, the connection state determination unit 62 determines that the first category is CAT13.

In a case where the state determination voltage VX is set to increase as the supplied electric power to the charging device 30 of the electric power supplying system 20 increases, the first upper limit threshold value can be the same as the second lower limit threshold value. In a case where the state determination voltage VX is set to increase as the supplied electric power to the charging device 30 of the electric power supplying system 20 increases, the second upper limit threshold value can be the same as the third lower limit threshold value.

The power supplying controller 68 is, for example, configured to control the electric power supplied to the charging device 30 by controlling the supplying state switching unit 66 based on the connection state determined by the connection state determination unit 62. The power supplying controller 68 is, for example, configured to control the electric power supplied to the charging device 30 based on at least one of the type of the charging device 30 and the type of the battery 12 corresponding to the determined connection state. This allows the power supplying device 50 to charge the battery 12 in a preferred manner with the supplied electric power for the at least one of the type of the charging device 30 and the type of the battery 12 corresponding to the connection state determined by the connection state determination unit 62.

The connection state determination unit 62 can be, for example, configured to determine whether the connection state is anomalous. An anomalous connection state includes, for example, a state in which the charging unit 36 is connected to the power supplying unit 54 but the power supplying device 50 cannot recognize whether the charging device 30 is under the first category. An anomalous connection state includes, for example, a case in which the charging device that is connected to the power supplying device 50 is not classified under the first category.

The connection state determination unit 62 is, for example, configured to determine that the connection state is anomalous in a case where the state determination voltage VX between the second charging unit line 40B and ground is outside a predetermined range. The predetermined range is, for example, greater than the first lower limit threshold value and less than or equal to the third upper limit threshold value. The predetermined range includes, for example, a range of the state determination voltage VX corresponding to a normal connection state. The range of the state determination voltage VX associated with a normal connection state includes, for example, a range of the state determination voltage VX associated with the first connection state, the second connection state, and the third connection state. In a state in which the charging device 30 is connected to the power supplying device 50, the connection state determination unit 62, for example, determines an anomalous connection state if the state determination voltage VX is outside the predetermined range.

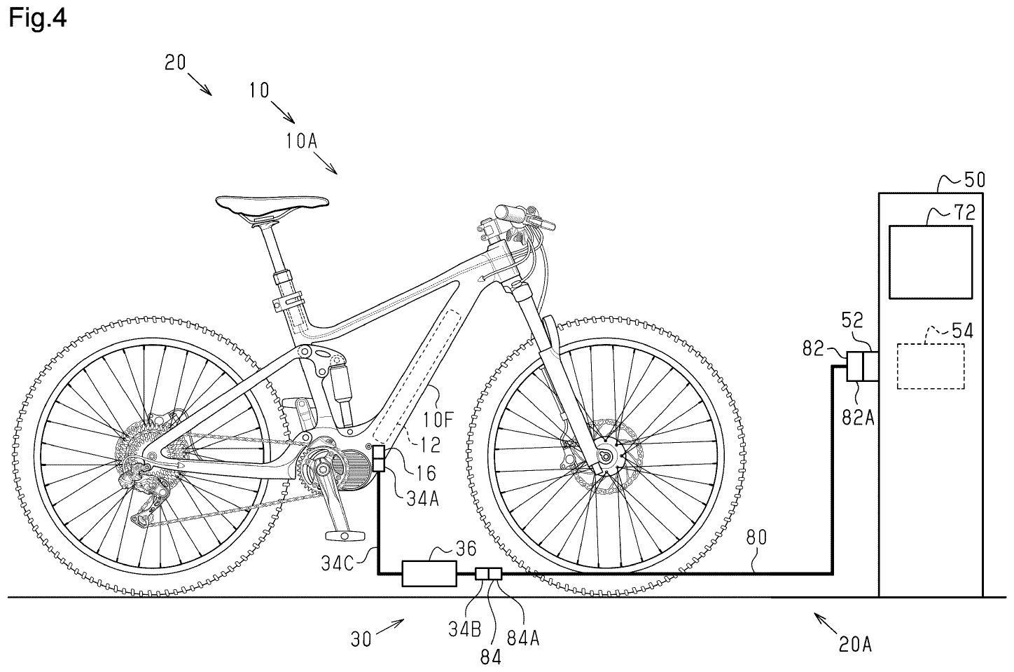

The charging device 30 can be directly connected to the power supplying device 50 or connected via an intermediate device 80 to the power supplying device 50. FIGS. 1 to 3 show an example in which the charging device 30 is directly connected to the power supplying device 50, and FIGS. 4 to 6 show an example in which the charging device 30 is connected via the intermediate device 80 to the power supplying device 50.

The electric power supplying system 20 shown in FIG. 4 further includes the intermediate device 80. The intermediate device 80 is connected between the power supplying device 50 and the charging device 30. The intermediate device 80, for example, supplies electric power from the power supplying device 50 to the charging device 30.

The electric power supplying system 20 includes, for example, the power supplying assembly 20A. The power supplying assembly 20A is connected to, for example, the charging device 30. The power supplying assembly 20A includes the power supplying device 50 and the intermediate device 80. In the example shown in FIGS. 4 to 6, the intermediate device 80 is connected to the charging device 30.

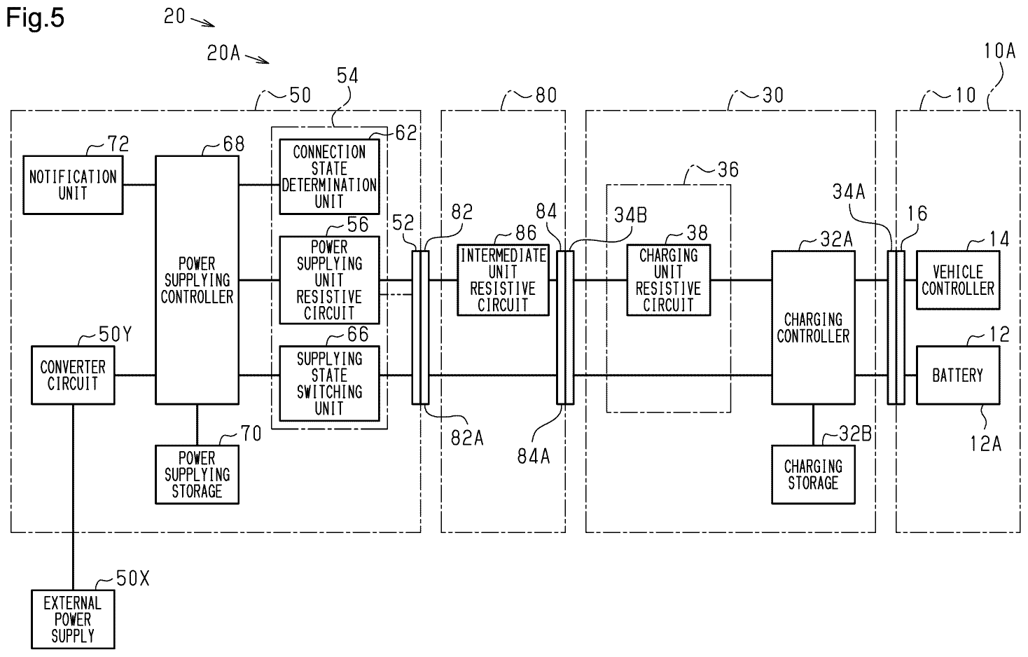

As shown in FIG. 5, the intermediate device 80 includes, for example, a first intermediate unit 82, a second intermediate unit 84, and an intermediate unit resistive circuit 86. The first intermediate unit 82 is configured to be connectable to the power supplying unit 54. The second intermediate unit 84 is configured to be connectable to the charging unit 36. The first intermediate unit 82 includes a first intermediate connector 82A that is connectable to the power supplying connector 52 of the power supplying device 50. The first intermediate connector 82A can also be referred to as a first intermediate electrical connector 82A. The second intermediate unit 84 includes a second intermediate connector 84A that is connectable to the power supplying device-side wire connector 34B of the charging device 30. The second intermediate connector 84A can also be referred to as a second intermediate electrical connector 84A.

The intermediate device 80 includes, for example, an intermediate electric wire provided between the first intermediate connector 82A and the second intermediate connector 84A. The intermediate electric wire is, for example, an electric cable. The intermediate unit resistive circuit 86 is, for example, provided between the first intermediate unit 82 and the second intermediate unit 84. The intermediate unit resistive circuit 86 is, for example, provided on the intermediate electric wire.

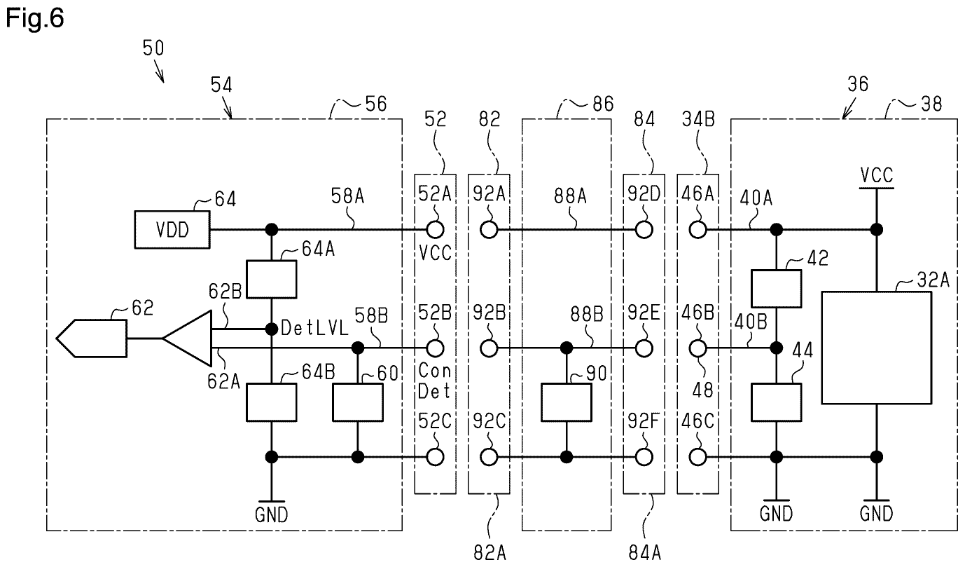

As shown in FIG. 6, the intermediate unit resistive circuit 86 includes, for example, a first intermediate unit line 88A, a second intermediate unit line 88B, and a third pull-down resistor 90. The first intermediate unit line 88A is electrically connected to, for example, the first power supplying unit line 58A and the first charging unit line 40A. The second intermediate unit line 88B is electrically connected to, for example, the second power supplying unit line 58B and the second charging unit line 40B. The third pull-down resistor 90 is connected, for example, between the second intermediate unit line 88B and ground. The intermediate device 80, for example, does not include a pull-up resistor such as the pull-up resistor 42 of the charging device 30.

The first intermediate connector 82A includes, for example, a first intermediate terminal 92A, a second intermediate terminal 92B, and a third intermediate terminal 92C. The first intermediate terminal 92A is connected to the first intermediate unit line 88A. The second intermediate terminal 92B is connected to the second intermediate unit line 88B. The third intermediate terminal 92C is connected to ground. In a case where the first intermediate unit 82 is connected to the power supplying unit 54, the first intermediate terminal 92A is connected to the first power supplying terminal 52A, the second intermediate terminal 92B is connected to the second power supplying terminal 52B, and the third intermediate terminal 92C is connected to the third power supplying terminal 52C.

The second intermediate connector 84A includes a fourth intermediate terminal 92D, a fifth intermediate terminal 92E, and a sixth intermediate terminal 92F. The fourth intermediate terminal 92D is connected to the first intermediate unit line 88A. The fifth intermediate terminal 92E is connected to the second intermediate unit line 88B. The sixth intermediate terminal 92F is connected to ground. In a case where the second intermediate unit 84 is connected to the charging unit 36, the fourth intermediate terminal 92D is connected to the first charging terminal 46A, the fifth intermediate terminal 92E is connected to the second charging terminal 46B, and the sixth intermediate terminal 92F is connected to the third charging terminal 46C.

In the example shown in FIGS. 4 to 6, the voltage ConDet at the second power supplying terminal 52B is decreased by the pull-up resistor 42, the first pull-down resistor 44, the second pull-down resistor 60, and the third pull-down resistor 90.

The intermediate device 80 is classified under a second category in accordance with the electric power condition of the charging device 30, which corresponds to the intermediate device 80. The second category includes, for example, CAT21, CAT22, and CAT23. The third pull-down resistor 90 of the intermediate device 80 has a third pull-down resistance RD30 that is set in accordance with, for example, the second category.

The intermediate device 80 corresponds to, for example, one or more types of the charging device 30. The intermediate device 80 that is classified as CAT21 corresponds to, for example, the charging device 30 that is classified as CAT11. The intermediate device 80 that is classified as CAT22 corresponds to, for example, the charging device 30 that is classified as CAT11 or CAT12. The intermediate device 80 that is classified as CAT23 corresponds to, for example, the charging device 30 that is classified as any one of CAT11, CAT12, and CAT13. The intermediate device 80 can be configured so that it cannot be connected to the charging device 30.

Table 3 shows the relationship of the first category, the second category, the pull-up resistance RU, the first pull-down resistance RD10, the second pull-down resistance RD20, the third pull-down resistance RD30, and the state determination voltage VX. In Table 3, the second pull-down resistance RD20 is the second pull-down resistance RD21 in each type of the first category. The second pull-down resistance RD21 is, for example, equal to RU2. RD31 is, for example, equal to RD11. RD32 is, for example, equal to RD12. RD33 is, for example, equal to RD13. In Table 3, the state determination voltages VX7 and VX8 are greater than the state determination voltages VX4, VX5, and VX6. In Table 3, the state determination voltage VX9 is greater than the state determination voltages VX7 and VX8.

TABLE 3

| | | | | | | 2nd | |
|---|---|---|---|---|---|---|---|
| | | | | | | Combined | |
| | | | 1st Pull- | 2nd Pull- | 3rd Pull- | Pull- | |
| | | | Down | Down | Down | Down | State |
| 1st | 2nd | Pull-Up | Resistance | Resistance | Resistance | Resistance | Determination |
| Category | Category | Resistance | RD10 | RD20 | RD30 | RDB | Voltage VX |
| CAT11 | CAT21 | RU1 | RD11 | RD21 | RD31 | RDB1 | VX4 |
| CAT11 | CAT22 | RU1 | RD11 | RD21 | RD32 | RDB2 | VX5 |
| CAT11 | CAT23 | RU1 | RD11 | RD21 | RD33 | RDB3 | VX6 |
| CAT12 | CAT22 | RU2 | RD12 | RD21 | RD32 | RDB4 | VX7 |
| CAT12 | CAT23 | RU2 | RD12 | RD21 | RD33 | RDB5 | VX8 |
| CAT13 | CAT23 | RU3 | RD13 | RD21 | RD33 | RDB6 | VX9 |

In Table 3, the second combined pull-down resistance RDB indicates the combined resistance of the first pull-down resistor 44, the second pull-down resistor 60, and the third pull-down resistor 90. The second combined pull-down resistance RDB is acquired through, for example, Equation 2, which is shown below. The state determination voltage VX is a voltage decreased from voltage VDD by the pull-up resistance RU and the second combined pull-down resistance RDB.

RDB=1/(1/RD10+1/RD20+1/RD30) Equation 2

In Table 3, which shows examples of each resistance, if the voltage VDD of the voltage application unit 64 is 5 V, the state determination voltage VX4 is, for example, 0.61 V. In Table 3, which shows examples of each resistance, if the voltage VDD of the voltage application unit 64 is 5 V, the state determination voltage VX5 is, for example, 0.78 V. In Table 3, which shows examples of each resistance, if the voltage VDD of the voltage application unit 64 is 5 V, the state determination voltage VX6 is, for example, 0.83 V. In Table 3, which shows examples of each resistance, if the voltage VDD of the voltage application unit 64 is 5 V, the state determination voltage VX7 is, for example, 1.52 V. In Table 3, which shows examples of each resistance, if the voltage VDD of the voltage application unit 64 is 5 V, the state determination voltage VX8 is, for example, 1.64 V. In Table 3, which shows examples of each resistance, if the voltage VDD of the voltage application unit 64 is 5 V, the state determination voltage VX9 is, for example, 2.26 V.

For example, the pull-up resistance RU, the first pull-down resistance RD10, the second pull-down resistance RD20, and the third pull-down resistance RD30 are set so that the state determination voltage VX4, which corresponds to the combination of CAT11 and CAT21, the state determination voltage VX5, which corresponds to the combination of CAT11 and CAT22, and the state determination voltage VX6, which corresponds to the combination of CAT11 and CAT23, are each greater than the first lower limit threshold value and less than or equal to the first upper limit threshold value. For example, the pull-up resistance RU, the first pull-down resistance RD10, the second pull-down resistance RD20, and the third pull-down resistance RD30 are set so that the state determination voltage VX7, which corresponds to the combination of CAT12 and CAT22, and the state determination voltage VX8, which corresponds to the combination of CAT12 and CAT23, are each greater than the second lower limit threshold value and less than or equal to the second upper limit threshold value. For example, the pull-up resistance RU, the first pull-down resistance RD10, the second pull-down resistance RD20, and the third pull-down resistance RD30 are set so that the state determination voltage VX9, which corresponds to the combination of CAT13 and CAT23, are each greater than the third lower limit threshold value and less than or equal to the third upper limit threshold value. This allows the connection state determination unit 62 to determine the connection state in a preferred manner even in a case where the intermediate device 80 is connected between the power supplying device 50 and the charging device 30.

An anomalous connection state can include a state in which the intermediate device 80 connected between the power supplying device 50 and the charging device 30 is not classified under the second category. The intermediate device 80, which is not classified under any second category, includes, for example, the third pull-down resistor 90 having the third pull-down resistance RD30 so that the state determination voltage VX is outside the predetermined range. The intermediate device 80, which is not classified under any second category includes, for example, the third pull-down resistor 90 having the third pull-down resistance RD30 so that the state determination voltage VX becomes less than or equal to the first lower limit threshold value. The intermediate device 80, which is not classified under any of the second categories includes, for example, the third pull-down resistor 90 having the third pull-down resistance RD30 so that the state determination voltage VX becomes greater than the third upper limit threshold value. The intermediate device 80, which is not classified under any of the second categories includes, for example, an intermediate device 80 that does not electrically connect the power supplying connector 52 of the power supplying device 50 and the power supplying device-side wire connector 34B of the charging device 30. The connection state determination unit 62 can determine that the connection state is anomalous in a case where the state determination voltage VX is not included in any one of Table 2 and Table 3.

An anomalous connection state can include, for example, a state in which two or more intermediate devices 80 are connected. In the electric power supplying system 20, for example, the third pull-down resistance RD30 can be set so that the connection of two or more intermediate devices 80 causes the voltage ConDet to be decreased for a large amount such that the state determination voltage VX shifts to outside the predetermined range.

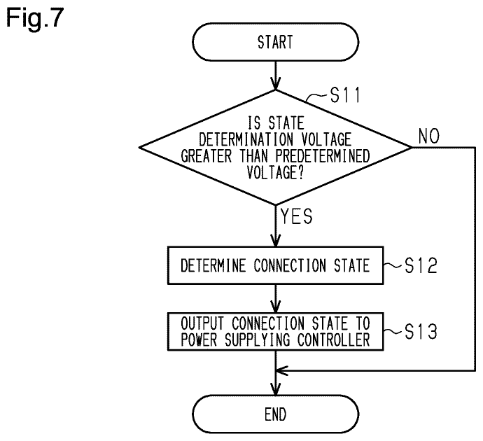

With reference to FIG. 7, a process executed by the connection state determination unit 62 will now be described. The connection state determination unit 62 starts the process of FIG. 7 from step S11, for example, upon the supply of electric power to the power supplying unit 54. If the process of the flowchart shown in FIG. 7 ends, the connection state determination unit 62, for example, repetitively executes the process from step S11 after a predetermined period elapses until the supply of electric power stops.

In step S11, the connection state determination unit 62 determines whether the state determination voltage VX is greater than a predetermined voltage. The state determination voltage VX is, for example, the voltage ConDet at the second power supplying terminal 52B. The predetermined voltage is, for example, the voltage DetLVL. In a case where the state determination voltage VX is greater than the predetermined voltage, the connection state determination unit 62 proceeds to step S12. In a case where the state determination voltage VX is not greater than the predetermined voltage, the connection state determination unit 62 ends the process of FIG. 7. In a case where the state determination voltage VX is not greater than the predetermined voltage, for example, the charging device 30 is not connected to the power supplying device 50.

In step S12, the connection state determination unit 62 determines the connection state and then proceeds to step S12. In step S13, the connection state determination unit 62 outputs the determined connection state to the power supplying controller 68 and then ends the process of FIG. 7.

The power supplying controller 68, for example, controls the supplying state switching unit 66 in accordance with the connection determined by the connection state determination unit 62. The power supplying controller 68, for example, controls the supplying state switching unit 66 to switch from a non-supplying state to one of the first supplying state, the second supplying state, and the third supplying state in accordance with the connection state determined by the connection state determination unit 62. The power supplying controller 68, for example, controls the supplying state switching unit 66 so as not to switch from a non-supplying state to a supplying state in a case where the connection state is anomalous.

The power supplying controller 68 can, for example, control the notification unit 72 in accordance with the connection state determined by the connection state determination unit 62. The notification unit 72, for example, notifies the user of the content of the connection state determined by the connection state determination unit 62.

In the electric power supplying system 20 of the present embodiment, the power supplying device 50 determines the connection state of the power supplying device 50 and the charging device 30. This allows the battery 12 to be charged in a preferred manner in accordance with the supplying state selected by the power supplying device 50. In the power supplying device 50 of the present embodiment, the power supplying unit resistive circuit 56 and the charging unit resistive circuit 38 are energized upon connection of the power supplying device 50 and the charging device 30 to allow for early determination of the connection state. The power supplying device 50 determines the connection state by detecting the state determination voltage VX. This allows the connection state to be determined with a simple structure.

### Modifications

The description related with the above embodiment exemplifies, without any intention to limit, applicable forms of an electric power supplying system for a vehicle, a power supplying assembly for a vehicle, and a power supplying device for a vehicle according to the present disclosure. The electric power supplying system for a vehicle, the power supplying assembly for a vehicle, and the power supplying device for a vehicle according to the present disclosure are applicable to, for example, modifications of the above embodiment that are described below and combinations of at least two of the modifications that are consistent with each other. In the modifications described hereinafter, same reference numerals are given to those elements that are the same as the corresponding elements of the above embodiment. Such elements will not be described in detail.

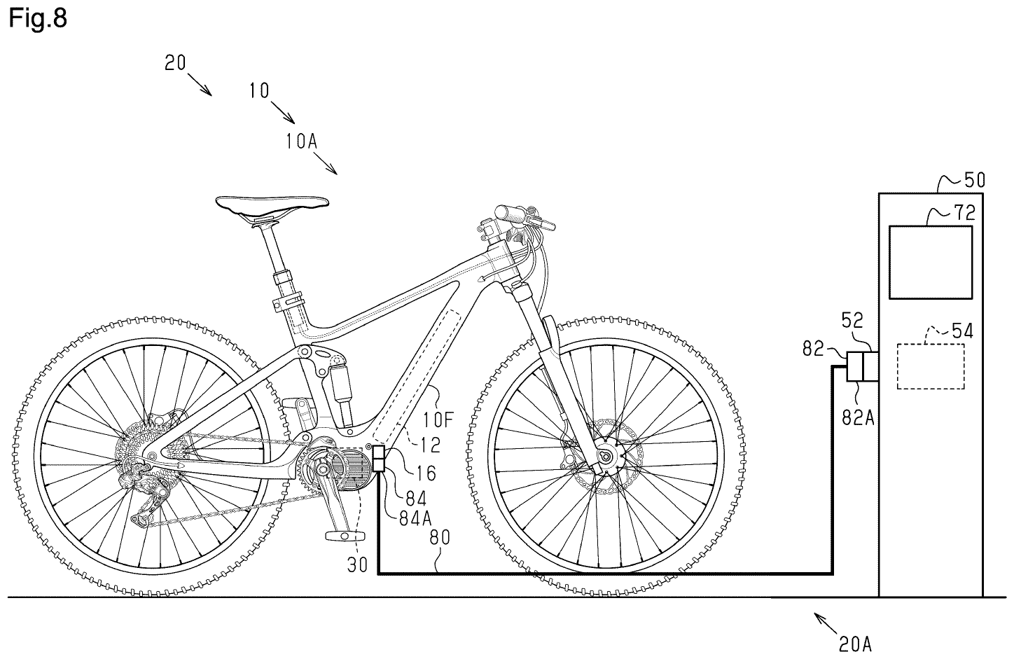

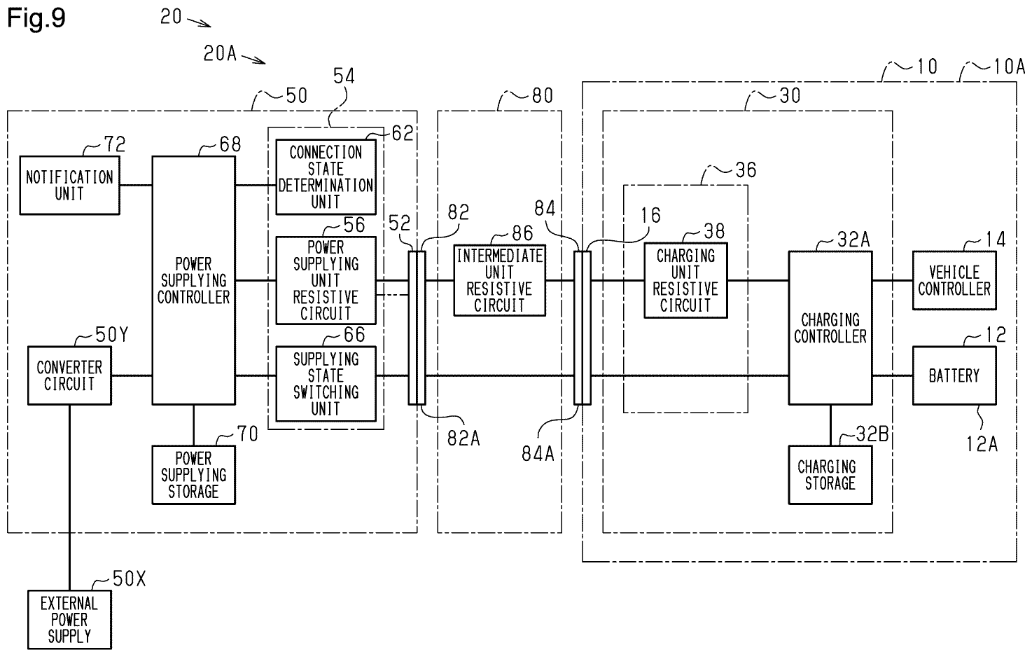

As shown in FIGS. 8 and 9, at least part of the charging device 30 can be provided on the vehicle 10. The entire charging device 30 can be provided on the vehicle 10. In the present modification, the charging device 30 is, for example, accommodated in the frame 10F of the human-powered vehicle 10A. The charging unit 36 is provided between the vehicle connector 16 and the battery 12. In a case where the electric power supplying system 20 includes the intermediate device 80, the second intermediate unit 84 of the intermediate device 80 can be configured to be connected to the vehicle connector 16. In the present modification, the electric wire 34C extending from the charging device 30 between the charging unit 36 and the battery 12 is omitted, and the charging device 30 can be directly connected to the battery 12 by terminals or the like. At least part of the charging device 30 can be provided on an electric component. At least part of the charging device 30 can be provided on the battery 12.

The power supplying device 50 can be configured to determine the connection state with information other than the state determination voltage VX. The charging storage 32B stores, for example, information related to the electric power conditions of the charging device 30. In a case where the power supplying device 50 is connected to, for example, the charging device 30, the power supplying device 50 requests the charging device 30 for information related to the electric power conditions of the charging device 30. The connection state determination unit 62 is, for example, configured to determine the connection state based on the electric power conditions of the charging device 30.

As long as the connection state determination unit 62 of the power supplying device 50 determines the connection state, there is no particular limitation to the structures of the charging unit resistive circuit 38 and the power supplying unit resistive circuit 56. For example, a structure can be added to the charging unit resistive circuit 38 to apply voltage to the power supplying unit 54 that corresponds to the state determination voltage VX associated with the first category of the charging device 30. The intermediate unit resistive circuit 86 can include an additional structure that applies voltage to the power supplying unit 54 that corresponds to the state determination voltage VX associated with the second category of the intermediate device 80.

The state determination voltage VX can be a voltage between the voltage ConDet at the second power supplying terminal 52B and the voltage VCC at the first power supplying terminal 52A. As long as the state determination voltage VX reflects the resistances of the pull-up resistor 42 and the first pull-down resistor 44, the state determination voltage VX can be the voltage measured at any part.

The connection state determination unit 62 can be configured so that it does not determine whether the connection state is anomalous. In the present modification, the connection state determination unit 62 is, for example, configured to determine only whether the connection state is the first connection state, the second connection state, or the third connection state.

The charging device 30 can be configured to charge a battery 12 that differs from the first battery 12A, the second battery 12B, and the third battery. The charging device 30 can be capable of charging four or more types of the battery 12.

The electric wire 34C between the charging unit 36 and the power supplying device 50 can be omitted from the charging device 30. In the present modification, for example, an electric cable including the power supplying connector 52 can be provided at an end of the power supplying device 50.

The power supplying device 50 does not have to include the notification unit 72.

The connection state determination unit 62 can be configured to determine whether the intermediate device 80 is connected between the power supplying device 50 and the charging device 30 upon connection of the charging unit 36 to the power supplying unit 54 via the intermediate device 80. For example, in the present modification, the third pull-down resistance RD30 is set so that connection of the intermediate device 80 can be determined from the state determination voltage VX. In the present modification, the electric power supplying system 20 can further include a resistive circuit to determine whether the intermediate device 80 is connected.

The connection state determination unit 62 can be configured to determine the type of the intermediate device 80 connected between the power supplying device 50 and the charging device 30. The type of the intermediate device 80 includes, for example, the second category of the intermediate device 80. For example, in the present modification, the third pull-down resistance RD30 is set so that the type of the intermediate device 80 is determined from the state determination voltage VX. In the modification, the electric power supplying system 20 can further include a resistive circuit to determine the type of the intermediate device 80.

As long as the power supplying unit resistive circuit 56 includes a power supplying unit line and a charging unit line, other structures can be omitted from the power supplying device 50. The power supplying unit line includes, for example, the second power supplying unit line 58B that is electrically connected to the second charging unit line 40B, which is included in the charging unit line of the charging unit 36. The pull-down resistor includes, for example, the second pull-down resistor 60, which is connected between the second power supplying unit line 58B and ground.

In either one of the intermediate device 80 or the power supplying assembly 20A, as long as the intermediate device 80 includes the intermediate unit resistive circuit 86 and the intermediate unit resistive circuit 86 includes an intermediate unit line and a pull-down resistor, other structures can be omitted. The intermediate unit line includes the second intermediate unit line 88B that is electrically connected to the second power supplying unit line 58B, which is included in the power supplying unit line. The pull-down resistor includes the third pull-down resistor 90, which is connected between the second intermediate unit line 88B and ground. The second intermediate unit line 88B electrically connects the charging unit 36 and the power supplying unit 54.

In this specification, the phrase “at least one of”′ as used in this disclosure means “one or more” of a desired choice. As one example, the phrase “at least one of” as used in this disclosure means “only one single choice” or “both of two choices” if the number of its choices is two. As another example, the phrase “at least one of” as used in this disclosure means “only one single choice” or “any combination of two or more choices” if the number of its choices is three or more. Also, the term “and/or” as used in this disclosure means “either one of or both of.” For instance, the phrase “at least one of A and B” encompasses (1) A alone, (2) B alone, and (3) both A and B. The phrase “at least one of A, B, and C” encompasses (1) A alone, (2) B alone, (3) C alone, (4) both A and B, (5) both B and C, (6) both A and C, and (7) all A, B, and C. In other words, the phrase “at least one of A and B” does not mean “at least one of A and at least one of B” in this disclosure.

### Description of Reference Characters

10) vehicle, 10A) human-powered vehicle, 12) battery, 12A) first battery, 12B) second battery, 20) electric power supplying system, 20A) power supplying assembly, 30) charging device, 30A) first charging device, 30B) second charging device, 34C) electric wire, 36) charging unit, 38) charging unit resistive circuit, 40A) first charging unit line, 40B) second charging unit line, 42) pull-up resistor, 44) first pull-down resistor, 48) connection notification unit, 50) power supplying device, 54) power supplying unit, 56) power supplying unit resistive circuit, 58A) first power supplying unit line, 58B) second power supplying unit line, 60) second pull-down resistor, 62) connection state determination unit, 66) supplying state switching unit, 68) power supplying controller, 70) power supplying storage, 72) notification unit, 80) intermediate device, 82) first intermediate unit, 84) second intermediate unit, 86) intermediate unit resistive circuit, 88A) first intermediate unit line, 88B) second intermediate unit line, 90) third pull-down resistor

What is claimed is:

1. An electric power supplying system for a vehicle, the electric power supplying system comprising:
a power supplying device provided outside the vehicle and including a power supplying unit; and
a charging device configured to charge a battery of the vehicle with electric power supplied from the power supplying device and including a charging unit configured to be connectable to the power supplying unit,
the power supplying device including a connection state determination unit configured to determine a connection state of the power supplying device and the charging device.

2. The electric power supplying system according to claim 1, wherein
the power supplying unit includes a power supplying unit resistive circuit,
the charging unit includes a charging unit resistive circuit,
the power supplying unit resistive circuit includes a first power supplying unit line and a second power supplying unit line,
the charging unit resistive circuit includes a first charging unit line and a second charging unit line, and
a connection of the charging unit to the power supplying unit electrically connects the first charging unit line to the first power supplying unit line between the power supplying unit and the charging unit, and electrically connects the second power supplying unit line to the second charging unit line between the power supplying unit and the charging unit.

3. The electric power supplying system according to claim 2, wherein
the charging unit resistive circuit includes
a pull-up resistor connected between the first charging unit line and the second charging unit line, and
a first pull-down resistor connected between the second charging unit line and ground.

4. The electric power supplying system according to claim 3, wherein
the power supplying unit resistive circuit includes a second pull-down resistor connected between the second power supplying unit line and ground.

5. The electric power supplying system according to claim 4, wherein
the battery includes a first battery and a second battery that differs from the first battery,
the charging device includes
a first charging device configured to charge the first battery, and
a second charging device configured to charge the second battery,
the power supplying device is configured to be connected to one of the first charging device and the second charging device,
the connection state includes
a first connection state in which the first charging device is connected to the power supplying device, and
a second connection state in which the second charging device is connected to the power supplying device, and
the connection state determination unit is configured to determine whether the connection state is the first connection state or the second connection state.

6. The electric power supplying system according to claim 2, further comprising:
an intermediate device connected between the power supplying device and the charging device,
the connection state determination unit being configured to determine whether the intermediate device is connected between the power supplying device and the charging device upon connection of the charging unit to the power supplying unit via the intermediate device.

7. The electric power supplying system according to claim 6, wherein
the connection state determination unit is configured to determine a type of the intermediate device connected between the power supplying device and the charging device.

8. The electric power supplying system according to claim 6, wherein
the intermediate device includes a first intermediate unit configured to be connectable to the power supplying unit, a second intermediate unit configured to be connectable to the charging unit, and an intermediate unit resistive circuit provided between the first intermediate unit and the second intermediate unit,
the intermediate unit resistive circuit includes
a first intermediate unit line electrically connected to the first power supplying unit line and the first charging unit line,
a second intermediate unit line electrically connected to the second power supplying unit line and the second charging unit line, and
a third pull-down resistor connected between the second charging unit line and ground.

9. The electric power supplying system according to claim 2, wherein
the connection state determination unit is configured to determine whether the connection state is anomalous.

10. The electric power supplying system according to claim 9, wherein
the connection state determination unit is configured to determine that the connection state is anomalous in a case where a state determination voltage between the second charging unit line and ground is outside a predetermined range.

11. The electric power supplying system according to claim 10, wherein
the power supplying device further includes power supplying storage that stores association information associating the state determination voltage with the connection state, and
the connection state determination unit is configured to determine the connection state based on the state determination voltage and the association information.

12. The electric power supplying system according to claim 1, wherein
the power supplying device includes
a supplying state switching unit configured to switch a supplying state of electric power to the charging device, and
a power supplying controller configured to control the supplying state switching unit so that electric power is supplied to the charging device based on a determination result of the connection state obtained by the connection state determination unit.

13. The electric power supplying system according to claim 1, wherein
the charging device includes
an electric wire provided with the charging unit, and
a connection notification unit configured to transmit a connection signal to the connection state determination unit upon connection of the charging unit to the power supplying unit, and
the connection notification unit is provided on the electric wire.

14. The electric power supplying system according to claim 1, wherein
at least part of the charging device is provided on the vehicle.

15. The electric power supplying system according to claim 1, wherein
the power supplying device further includes a notification unit configured to notify a user of the connection state determined by the connection state determination unit.

16. The electric power supplying system according to claim 1, wherein
the vehicle includes a human-powered vehicle.

17. A power supplying device configured to be connected to a charging device configured to charge a battery of a vehicle, the power supplying device comprising:
a power supplying unit provided outside the vehicle and configured to be connectable to a charging unit of the charging device; and
a connection state determination unit configured to determine a connection state of the power supplying device and the charging device.

18. The power supplying device according to claim 17, wherein
the power supplying unit includes a power supplying unit resistive circuit,
the power supplying unit resistive circuit includes
a power supplying unit line electrically connected to a charging unit line of the charging unit, and
a pull-down resistor connected between the power supplying unit line and ground.

19. An intermediate device connected between a power supplying device and a charging device, the intermediate device comprising:
an intermediate unit resistive circuit,
the intermediate unit resistive circuit includes
an intermediate unit line electrically configured to be connected to a power supplying unit line, and
a pull-down resistor connected between the intermediate unit line and ground.

20. A power supplying assembly for a vehicle, the power supplying assembly comprising:
the power supplying device according to claim 17; and
an intermediate device connected between the power supplying device and the charging device,
the intermediate device including an intermediate unit resistive circuit,
the intermediate unit resistive circuit including
an intermediate unit line electrically connecting the charging unit and the power supplying unit, and
a pull-down resistor connected between the intermediate unit line and ground.
